(19) United States
(12) Patent Application Publication
(10) Pub. No.: US 2017/0039900 A1
(43) Pub. Date: Feb. 9, 2017

(54) METHOD OF ADVERTISING

(71) Applicant: Edward Scott KRAUSE, Itasca, IL (US)

(72) Inventor: Edward Scott KRAUSE, Itasca, IL (US)

(21) Appl. No.: 15/297,682

(22) Filed: Oct. 19, 2016

Related U.S. Application Data
(63) Continuation-in-part of application No. 15/042,497, filed on Feb. 12, 2016, now abandoned.
Application No. 15/042,497 is a continuation-in-part of application No. 14/641,792, filed on Mar. 9, 2015, now abandoned.
(60) Provisional application No. 61/950,044, filed on Mar. 8, 2014.

(51) Int. Cl. G09F 7/18; C09J 133/08; C09J 9/00

(52) U.S. Cl. CPC G09F 7/18; C09J 9/00; C09J 133/08

(57) ABSTRACT

A method for advertising using removably attachable sheets that facilitate acknowledgement of the message contained thereon is provided. The method embodies attachable sheets providing iterative adhesive having a distribution of a plurality of diminutive and enlarged adhesive microcapsules enabling iteratively repositioning of each sheet successively on a plurality of objects. The sheets may have at least one predetermined messages affixed thereto so that a user may spontaneously affix at least one desired message thereto, whereby the user may present potential consumers with the sheets in such a manner and with such a message so as to encourage interaction with and acknowledgement of the at least one message by the potential consumer.

### CROSS-REFERENCE TO RELATED APPLICATION

This application claims the benefit of priority of U.S. provisional application No. 61/950,044, filed Mar. 08, 2014, U.S. non-provisional application No. 14/641,792, filed Mar. 09, 2015, and U.S. non-provisional application No. 15/042,497, filed Feb. 12, 2016, the contents of which are herein incorporated by reference.

### BACKGROUND OF THE INVENTION

The present invention relates to methods of advertising and, more particularly, to a method of advertising using a removably attachable sheet.

Current methods of advertising to in-store clientele typically involves pushing a handout onto the potential customer and/or, for potential repeat customers, stuffing promotional material inside the packaging of a purchased good or service. Both are usually quickly discarded because of the played-out nature of the method, and, in the case of the latter, may never be seen.

Not only are these current methods ineffectual, they are inefficient for the employee to employ. They are also self-frustrating because their imaginatively bankrupt nature encourages potential customers to discarded or never acknowledge such solicitations as the empty gestures they are.

As can be seen, there is a need for a method of advertising using a removably attachable sheet that facilitates acknowledgement of the message contained thereon by, in certain instances, being employed on the exterior surface of objects.

### SUMMARY OF THE INVENTION

In one aspect of the present invention, a method for advertising so as to facilitate interaction and acknowledgement by a potential customer includes providing at least one sheet having an adhesive disposed along a portion thereof; affixing a predetermined message on the at least one sheet; and attaching the adhesive to an object of a potential customer so as to facilitate the potential customer's acknowledgement of the predetermined message when using the object.

In another aspect of the present invention, a method for advertising so as to facilitate interaction and acknowledgement by a potential customer includes providing to an agent at least one sheet having an adhesive disposed along a portion thereof; providing a pad of sheets wherein the at least one sheet is removably bound to a plurality of sheets; providing a dispenser for removably housing the pad; affixing a predetermined message on the at least one sheet; and assigning the agent to attach the adhesive to a portion of an object of each potential customer, wherein the portion of the object is prominently located.

In yet another aspect of the present invention, the method provides an iterative adhesive having a distribution of a plurality of diminutive microcapsules and enlarged microcapsules, wherein the plurality of diminutive microcapsules and enlarged microcapsules includes a first diminutive microcapsule having a diminutive volume ranging between 1/40th and 1/30th that of a enlarged volume of a first enlarged microcapsule, wherein the distribution of the plurality of diminutive microcapsules and enlarged microcapsules includes an approximately even distribution of the first diminutive microcapsule and the first enlarged microcapsule, wherein the distribution of the plurality of diminutive microcapsules and enlarged microcapsules includes a second diminutive microcapsule and a second enlarged microcapsules, wherein the second diminutive microcapsule is more voluminous than the diminutive volume, and wherein the second enlarged microcapsules is less voluminous than the enlarged volume, and wherein the distribution of the plurality of diminutive microcapsules and enlarged microcapsules includes an approximately even distribution of the first diminutive microcapsule, second diminutive microcapsule, the first enlarged microcapsule, and the second enlarged microcapsule.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention, shown in use;

FIG. 2 is a rear exploded view of an exemplary embodiment of the present invention;

FIG. 3 is a section view of an exemplary embodiment of the present invention, taken along line 4-4 in FIG. 1;

FIG. 4 is a perspective view of an exemplary embodiment of the present invention;

FIG. 5 is a perspective view of an exemplary embodiment of the present invention;

FIG. 6 is a section view of an exemplary embodiment of the present invention, taken along line 6-6 in FIG. 5;

FIG. 7 is a rear exploded view of an exemplary embodiment of the present invention;

FIG. 8 is a rear exploded view of an exemplary embodiment of the present invention;

FIG. 9 is a perspective view of an exemplary embodiment of the present invention;

FIG. 10 is a section view of an exemplary embodiment of the present invention, taken along line 10-10 in FIG. 9;

FIG. 11 is a detailed section view of an exemplary embodiment of the present invention, shown in use with an uneven or rough surface area; and

FIG. 12 is a detailed section view of an exemplary embodiment of the present invention, shown in use with a smooth surface area or texture.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a method for advertising using removably attachable sheets that facilitate acknowledgement of the message contained thereon. The sheets may have at least one predetermined messages affixed thereto or be blank so that a user may spontaneously affix at least one desired message thereto, whereby the user may present potential consumers with the sheets in such a manner and with such a message so as to encourage interaction with and acknowledgement of the at least one message by the potential consumer.

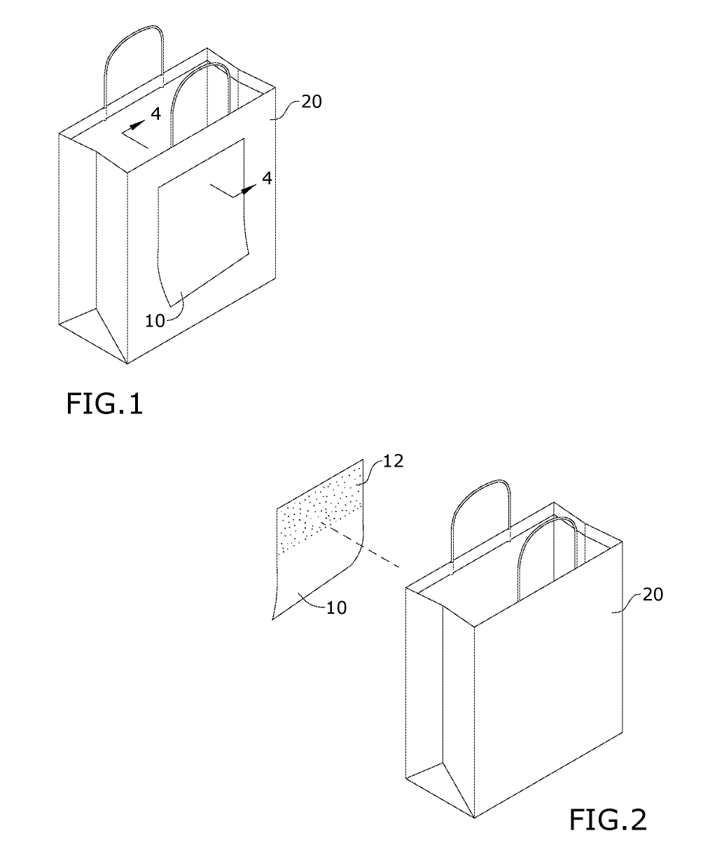

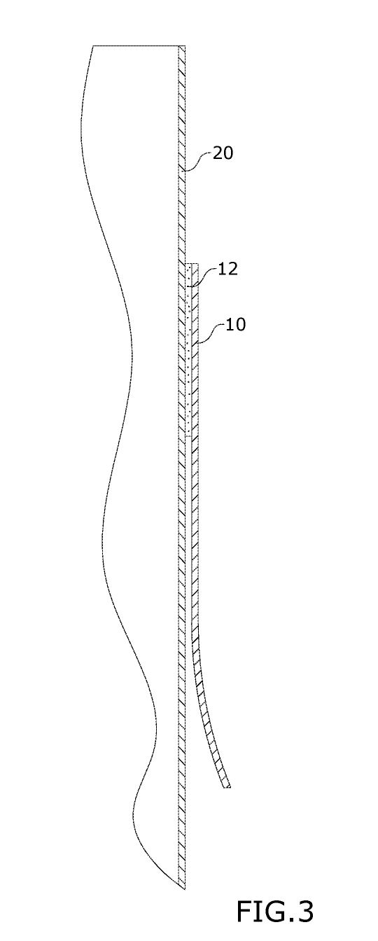

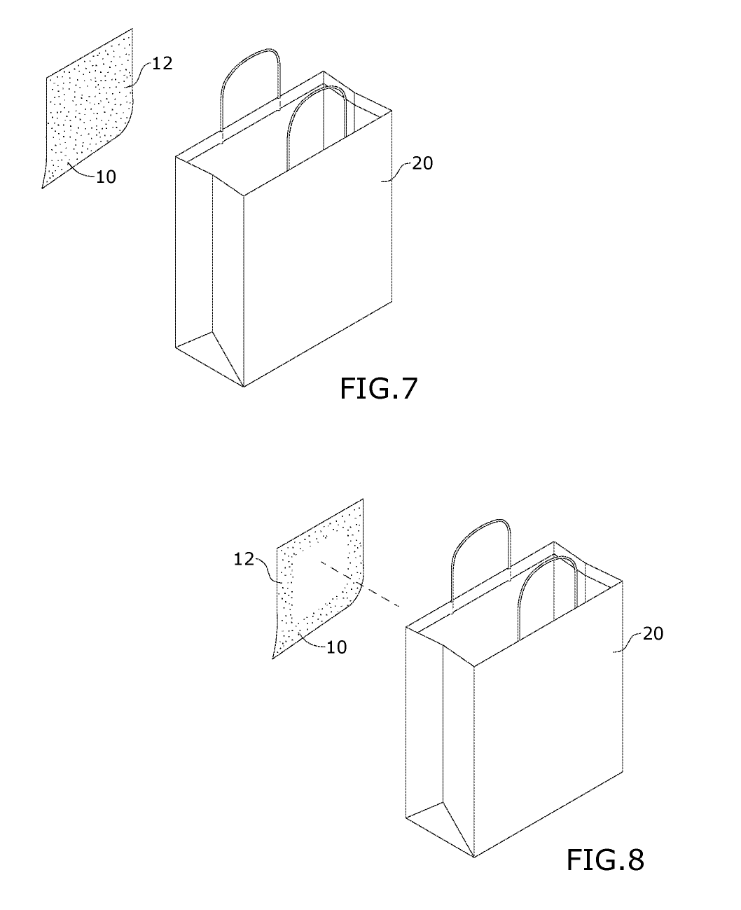

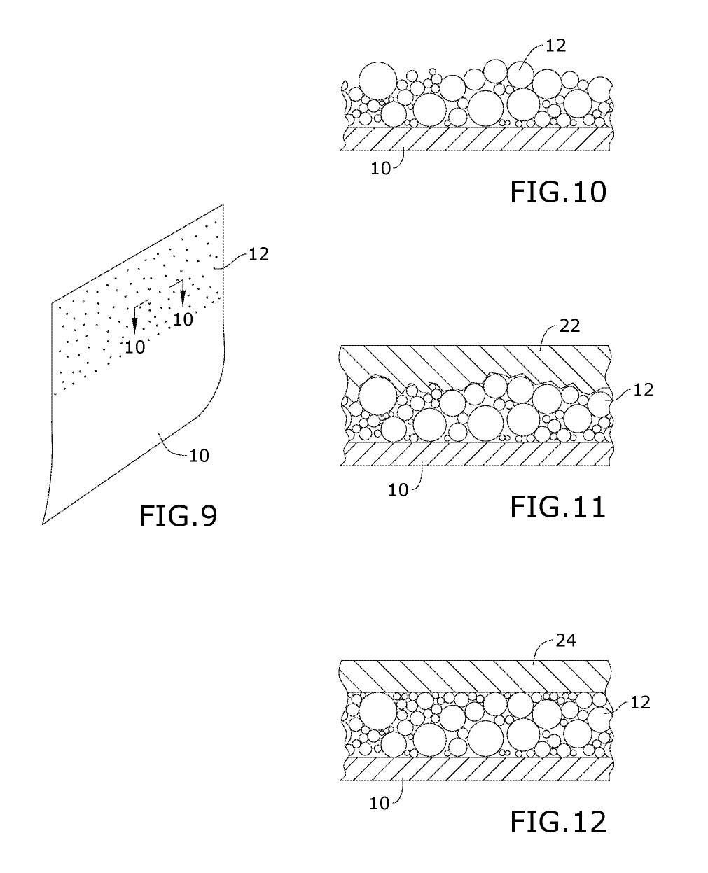

FIGS. 1 through 12 illustrate an advertising system 30 embodied in a method of the present invention for advertising using removably attachable sheets that facilitates acknowledgement of the message contained thereon. The advertising system 30 may include at least one bag hanger in the form of a sheet 10, a pad 14, and a dispenser 16. Each sheet 10 has an iterative adhesive 12 disposed on a portion thereof. The iterative adhesive 12, may be integrally formed into a portion of each sheet 10. In other embodiments, the repositionable adhesive 12, may be provided along a portion of each sheet 10, as a deposited bonding agent, a separate layer or the like, wherein the iterative adhesive 12 may be adapted to removably attach each sheet 10 to a succession of a plurality of objects 20, as illustrated in FIGS. 1 through 3 and 7 and 8. The object 20 may be paper-based and non-paper-based objects, such as paper bags and/or plastic bags, paper-based and non-paper-based packaging, or any other object sufficient to carry the adhered-to at least one sheet 10.

The iterative adhesive 12 may include acrylic microsphere adhesive providing a plurality of sizes of adhesive microcapsules, from diminutive to enlarged, as illustrated in FIGS. 10-12. The iterative repositionable adhesive 12 makes use of the distribution of enlarged microcapsules for removably adhering to a wide range of surfaces. The relative distribution of diminutive and enlarged adhesive microcapsules may vary as well based upon the material of the object 20 it needs to adhere to.

Other similar methods of advertising on the outside of packaging/containers using pressure sensitive adhesive, permanently adhere the item to the bag, or are not iteratively repositionable. The iterative adhesive 12 microsphere/microcapsule formation of the present invention affords significant improvements over traditional pressure sensitive adhesive and removable pressure sensitive adhesives, including clean removability from a variety of surfaces types (e.g., uneven surfaces 22 and even surfaces 24), consistent peel characteristics and the ability to adhere to various surfaces. The iterative adhesive 12 in conjunction with a method of marketing allows for the marketing message to be iteratively adhered to a successive various types of products, bags, packaging, containers (i.e., objects 20) allowing for the sheet 10 to be peeled off without damaging the packaging, bag or marketing message, and repositioned to somewhere useful for the customer and/or saved for later use or another object 20.

In certain embodiments, the smallest diminutive microcapsule may have a volume approximately 1/36th that of the largest enlarged microcapsule, with an approximately even distribution of said smallest diminutive and largest enlarged microcapsules within the iterative adhesive 12. An approximately even distribution of microcapsule sizes between said smallest diminutive and largest enlarged microcapsules may also be present in the iterative adhesive 12.

The iterative adhesive 12 may includes acrylic homopolymers, in certain embodiment 100%. In certain embodiments the iterative adhesive 12 is a water-based and food-safe. The iterative adhesive 12 is adapted to be repeatedly (iteratively) applied and reapplied (repositioned) to successive paper-based and non-paper based objects 20. Iterative adhesive 12 is distinguishable from prior art (conventional) repositionable adhesive, which are only repositionable in terms of being sufficiently operative only when positioned from their initial backing to a first object only. Thereafter, conventional repositionable adhesive loses sufficient operative adhesiveness to reliably remain adhered to a second object. This untrustworthiness stands athwart the method of advertising of the present invention, which teaches how to constantly promote, remind, interact with and demand the acknowledgment of a potential customer. Furthermore, the iterative adhesive 12 is distinguishable from other repositionable adhesive because it uses a distribution of a plurality of diminutive and enlarged microcapsules enabling attachment to a wider variety of surfaces/materials, such as paper bags, recycled paper bags, plastic bags, other non paper products, etc. (other repositionable adhesive has a very difficult time adhering to recycled paper bags). Moreover, the presence of a distribution of both enlarged and diminutive microcapsules allows the differently sized microcapsules to be iteratively repositioned/adhered along and into the plurality of differently sized crevices or contours provided along an uneven surface 22 of the object 20, as illustrated in FIG. 11. Such distribution enables a higher percentage of surface area contact between the iterative adhesive 20 and the surface of the object 20, improving the overall adhesion relative to conventional repositionable adhesives, as well as enabling the iterative adhesive to be iteratively reapplied to a succession of a plurality of objects 20. And with the presence of a plurality of differently sized microcapsules, the iterative adhesive 12 may be iteratively repositioned/adhered to a smooth surface 24 of an object 20, as illustrated in FIG. 12. It being understood that many non-paper-based materials, such as fabrics provide the uneven surface 22 have a plurality of variously sized crevices and contours that convention repositionable adhesive struggle to even initially (non-iteratively) adhere to.

As a result, the iterative adhesive 12 may be adapted to sufficiently removably attach the same sheet 10 from a first object 20, so as to be initially removably attached thereto, and be removed and effectively re-attached to a second object 20 so as to be removably attached thereto to be effectively re-attached to a third object. Iterative adhesive 12 is adapted to repeatedly removably adhere to paper, paper-products, and non-paper products such as fabrics such as leather, cloth, polymers and the like. In contrast, the prior art repositionable adhesive cannot be adhered to a first object and then a second object, and so a marketer interested in iteratively reapplying a sheet on a plurality of objects for the sake of making a sale would not rely on such prior art repositionable adhesive.

By way of example only, a seller of handbag shop may adhere—via the iterative adhesive 12—a sheet 10 to a to-go bag, i.e., shopping/gift/carry-out bag, (first object 20) of a paying customer of a sold handbag. Wherein the sheet 10 provides a predetermined message informing the paying customer that if they walk into said handbag shop with said sheet 10 adhered to said sold handbag (second object 20) they receive a discount accessories to said sold handbag. Iterative adhesive 12 facilitates such repeated application and thus the advertising method of the present invention, while mere repositionable adhesive does not.

Each sheet 10 may be a substrate of material suitable for affixing at least one message thereon by using known forms of written or printable communication. The material substrate may include but not limited to various forms of paper products. The material substrate may be any size, shape or dimensions so long as the material substrate/sheet 10 functions in accordance with the present invention as described herein. Each message may include but not be limited to any information desired to be imparted, such as an advertisement, a coupon, a display, a logo, trademark, slogan, contractual offer, promotional information, general information, and the like.

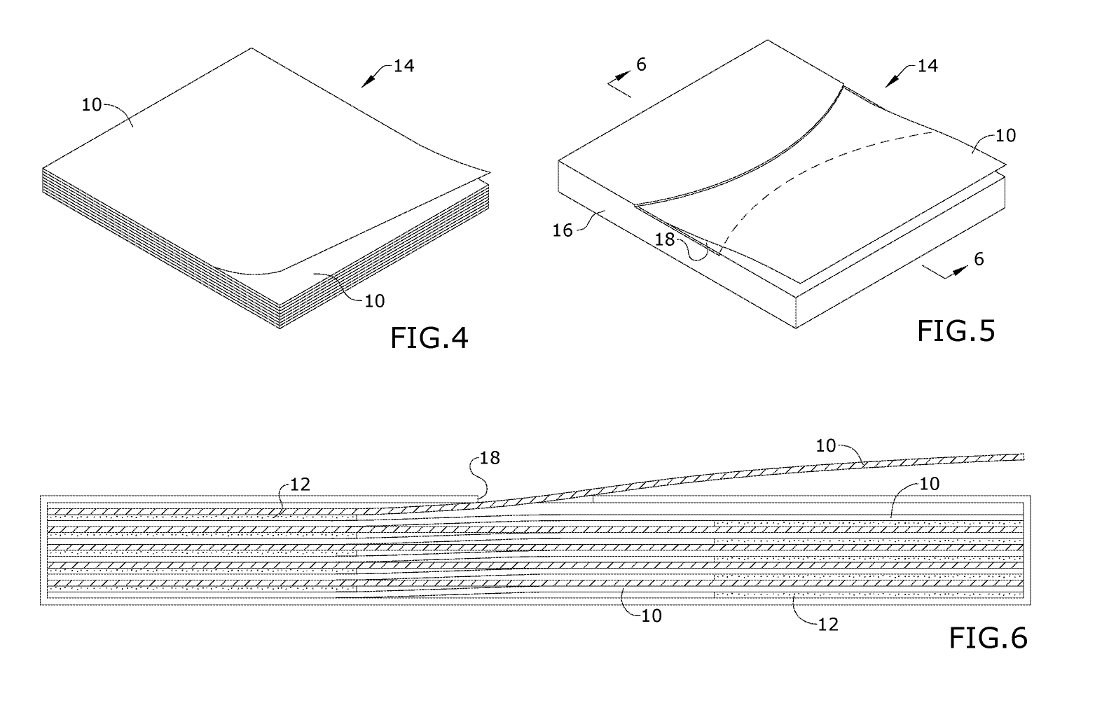

Each sheet 10 may be removably bound together in the pad 14, as illustrated in FIGS. 4 and 6. Each pad 14 may be removably housed in a dispenser 16 providing a dispensing opening 18 dimensioned and adapted to receive each sheet 10 when being dispensed, as illustrated in FIG. 5. Moreover, the dispensing opening 18 and the pad 14 may cooperate so that when the upper most sheet 10 is removed from the pad 14, through the dispensing opening 18, a portion of the adjacent sheet 10 is readily accessible through the same dispensing opening 18. In certain embodiments, the sheets 10 may be interleaved and the adhesive 12 disposed so that the portion of the adjacent sheet 10 may protrude through the dispensing opening 18, much like a paper towel in a paper towel dispenser.

The method of using the present invention may include the following. Providing the advertising system 30 disclosed above. A user may identify a potential customer and, after removing a predetermined sheet 10 from its pad 14, removably attach the predetermined sheet 10 to a prominent portion of an object 20 of the potential customer, such as the bag used for their most recent purchase. The predetermined sheet 10 may either have a predetermined message already affixed thereon or the user may spontaneously affix a desired message thereto.

By way of example, the method may include employees or agents of a retail store who are each given at least one sheet 10 with at least one predetermined message affixed thereto for spontaneously affixing desired messages thereto. In furtherance of the example, a store may give their point-of-sale employees (e.g., cashiers) a plurality of sheets 10 having sales-related messages, such as messaging “thanks for shopping with us,” coupons, or the like, that they removably attach to the packaging of each customer's purchase. Meanwhile, across the store at the entrance, employees (e.g., greeters) may have sheets 10 affixed with messages related to welcoming a potential customer, such messaging “welcome,” coupons, or the like, wherein such greeters may removably attach such sheets 10 to the clothing or other articles of the entering customer. The abovementioned sheets 10 could be carried around in bounded pads 14 as well as housed in at least one dispenser 16 for portable, efficient use.

The method also contemplates removably attaching each sheet 10 in meaningful location, whereby the potential customer is encouraged to interact and acknowledge the message. For example, the sheet 10 may be disposed on a side of a to-go bag, as illustrated FIG. 1. Moreover, the sheet 10 could be removably attached to the handles (first object 20) of the same to-go bag, so that the customer has to acknowledge it in order to carry out the to-go bag. Moreover, the method contemplates using more than one sheet 10 to convey one or more messages. For example, where there is a sheet 10 on the side (concomitant object) and the handles of the to-go bag, a message on the side sheet 10 may reference the handle sheet 10 in conveying its message. In one instance, the handle sheet 10 message may say, “if you find my ‘side-kick’, you get 50% off your next purchase if you bring us both in.” In such a manner, a third message may be formed (only) by combining the first and second predetermined message, thereby the third message enables an incentive to the potential customer—further facilitating the acknowledgment and affirmation of the advertising in the potential customer.

It should be understood, of course, that the foregoing relates to exemplary embodiments of the invention and that modifications may be made without departing from the spirit and scope of the invention as set forth in the following claims.

What is claimed is:

1. A method for advertising so as to facilitate interaction and acknowledgement by a potential customer, comprising:
providing at least one sheet having an iterative adhesive disposed along a portion thereof;
affixing a predetermined message on the at least one sheet; and
attaching the at least one sheet via the iterative adhesive to a first object of the potential customer, wherein the predetermined message instructs the potential customer to re-attach the at least one sheet via said iterative adhesive to a second object.

2. The method of claim 1, wherein the iterative adhesive includes a distribution of a plurality of diminutive microcapsules and enlarged adhesive microcapsules.

3. The method of claim 2, wherein the plurality of diminutive adhesive microcapsules and enlarged adhesive microcapsules includes a first diminutive adhesive microcapsule having a diminutive volume ranging between 1/40th and 1/30th that of a enlarged volume of a first enlarged adhesive microcapsule.

4. The method of claim 3, wherein the distribution of the plurality of diminutive microcapsules and enlarged adhesive microcapsules includes an approximately even distribution of the first diminutive adhesive microcapsule and the first enlarged adhesive microcapsule.

5. The method of claim 4, wherein the distribution of the plurality of diminutive adhesive microcapsules and enlarged adhesive microcapsules includes a second diminutive adhesive microcapsule and a second enlarged adhesive microcapsules, wherein the second diminutive adhesive microcapsule is more voluminous than the diminutive volume, and wherein the second enlarged adhesive microcapsules is less voluminous than the enlarged volume.

6. The method of claim 5, wherein the distribution of the plurality of diminutive microcapsules and enlarged microcapsules includes an approximately even distribution of the first diminutive microcapsule, second diminutive microcapsule, the first enlarged microcapsule, and the second enlarged microcapsule.

7. The method of claim 6, further including a pad, wherein the at least one sheet is removably bound to a plurality of sheets.

8. The method of claim 6, further including a dispenser for removably housing the at least one sheet.

9. The method of claim 7, further including a dispenser for removably housing the pad.

10. The method of claim 6, further providing at least one second sheet having a second message thereon; and attaching the at least one second sheet to a concomitant object, wherein the predetermined message promotes combining said predetermined and second messages.

11. The method of claim 10, wherein the second message references the predetermined message.

12. The method of claim 11, wherein the second message combined with the predetermined message forms a third message, wherein only the third message enables an incentive to the potential customer.

13. The method of claim 6, wherein the first object is at least one handle of a to-go bag.

14. The method of claim 6, wherein the first object is an article of clothing of the potential customer.

15. The method of claim 6, wherein the second object is a previously purchased good.

16. A device, comprising:
a sheet providing a printed marketing message; and
an iterative adhesive provided along a portion of the sheet, wherein the iterative adhesive includes relatively enlarged microcapsules and relatively diminutive microcapsules.

17. The device of claim 16, wherein the relatively enlarged microcapsules and relatively diminutive microcapsules are approximately evenly distributed.

18. The device of claim 17, wherein a volume of each relatively diminutive microcapsule is between 1/40th and 1/30th of a volume of each relatively enlarged microcapsule.

19. The device of claim 18, wherein the relatively diminutive microcapsules include first and second diminutive microcapsules, wherein the first diminutive microcapsules are smaller than the second diminutive microcapsules; and wherein the relatively enlarged microcapsules include first and second enlarged microcapsules, wherein the first enlarged microcapsules are smaller than the second enlarged microcapsules.

20. The device of claim 19, wherein the first and second diminutive microcapsules are relatively evenly distributed; and wherein the first and second enlarged microcapsules are relatively evenly distributed.
